(19) United States
(12) Patent Application Publication
(10) Pub. No.: US 2013/0244621 A1
(43) Pub. Date: Sep. 19, 2013

(54) MOBILE SERVICE DISTRIBUTION AND PROVISIONING ARCHITECTURE

(71) Applicants: Ryan K. Wuerch, Medina, WA (US); James P. Ryan, Roswell, GA (US)

(72) Inventors: Ryan K. Wuerch, Medina, WA (US); James P. Ryan, Roswell, GA (US)

(73) Assignee: SOLAVEI LLC, Bellevue, WA (US)

(21) Appl. No.: 13/421,616

(22) Filed: Mar. 15, 2012

(51) Int. Cl. H04W 4/00

(52) U.S. Cl. 455/414.1

(57) ABSTRACT

Various subscriber acquisition tools for mobile and other services are described. Members' mobile devices include a user interface with a selectable option that causes the display of transaction screens for provision of the new service for a prospective member. The transaction screens are interactive to receive prospective member information for provision of the new service. Member information that is associated with the mobile device is also transmitted to the transaction service. The member information is usable by the transaction service to correlate the provision of the service for the prospective member to an existing member service. Also described are social networking tools for new member acquisition.

### BACKGROUND

Mobile telephone service providers have traditionally engaged in expensive advertising in order to obtain new customers. This includes traditional television, radio, and print advertising, as well as online advertising such as with social media, search engines, and content providers. In addition, the mobile service business experiences a high rate of customer churn as there has been little reason for customers to stay with one service. Finally, the economics of providing mobile service has been challenged as carriers are often forced to subsidize the up-front cost of new mobile phones to help entice new customers. Mobile carriers end up providing service to a new customer for many months before the carrier is able to recoup the cost of the handset subsidy and the customer becomes profitable. As a result, the cost to obtain a new mobile subscriber is high.

Prospective customers typically obtain their mobile service by purchasing a mobile handset at a retail location, by dialing a provider's sales number, or by signing up for service on the provider's website. In exchange for a subsidized phone, the mobile customer typically agrees to a long-term contract with penalties for early termination. These contract terms are unpopular and lead to further customer churn when the contracts expire. As a result, mobile providers are often viewed with suspicion, have thin margins, and fight a never-ending and expensive battle for new subscribers.

### BRIEF SUMMARY

This Summary is provided in order to introduce simplified concepts of the present disclosure, which are further described below in the Detailed Description. This summary is not intended to identify essential features of the claimed subject matter, nor is it intended for use in determining the scope of the claimed subject matter.

This document describes tools that enable existing mobile subscribers to sign up new mobile subscribers in exchange for a commission or other benefits. The mobile subscriber (referred to herein as a “member”) launches a sign up tool from his or her mobile phone or web browser that allows him or her to sign up a new member during the member's normal daily interactions with their friends, coworkers, and family members. The sign up tool automatically ties the new member's service back to the member that referred them to the service, so that the referring member receives commissions or other benefits.

Mobile subscribers are provided with a wide range of tools to help them introduce and market the mobile service to their friends and family. These tools have capabilities to easily connect to existing social networks. These tools often include links to a website that allows prospective members to sign up for mobile service. The links are posted to the member's social networking site or sent to the member's contacts using a messaging tool (such as email, instant messaging, text messaging, and so forth). These links may include embedded information that is usable to tie the new member's service back to the existing member who referred them, so that the referring member may receive commissions or other benefits. The tools are provided, in various embodiments via member phones or other user devices (such as a tablet computer, netbook, personal computer, and so forth). In the same or different embodiments, the tools are provided via the internet, such as through a web service.

In embodiments, members are provided with commissions or other compensation for signing up members to new service. Embodiments include tools to motivate members to engage in additional activity. For example, in embodiments, members are provided with highly relevant reports, messages, and alerts—including in real time—that encourage the member to take steps to earn additional compensation. The reports, messages, and alerts may be provided through social networking feeds, emails, text messages, instant messages, and so forth. In various embodiments, members receive commissions or other compensation deposited to a bank account that is tied to a member debit card. The debit card itself is tied to the members' services, and may be used to make purchases.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an example system for acquisition of new members using mobile device tools.

FIG. 2 is a schematic diagram of an example system for acquisition of new members using social media tools.

FIGS. 3-9 are example transaction screens that are displayed during the sign-up process.

FIG. 10 is a social networking screen according to embodiments.

FIG. 11 is a block diagram of an example mobile device usable to provide member acquisition tools according to embodiments.

FIG. 12 is a block diagram of an example computing system usable to provide a transaction service.

FIG. 13 is a flow diagram showing an example process for provisioning service for a prospective member.

FIG. 14 is a flow diagram showing an example process for leveraging social networking services to solicit prospective members.

FIG. 15 is a flow diagram showing an example process for provisioning of member service through a member handset.

### DETAILED DESCRIPTION

### Overview

Embodiments of the present disclosure provide tools that enable a much more efficient and effective means to distribute and provision mobile services. Through this new approach, mobile subscribers—referred to herein as “members”—are enabled and provided with incentive to contact prospective members and sign them up for service. Members may receive commissions or other benefits for signing up new members. In turn, new members are similarly empowered to seek out individuals in their social network—both online and in the physical world—and get them to sign up. Acquiring new subscribers this way reduces costs by reducing or eliminating the need for traditional advertising.

According to various embodiments, a member's mobile handset is enabled, either through a soft link or an installed application, to operate as a new member acquisition tool. An existing member uses their handset or other mobile device to sign up new members while out with friends, having coffee with coworkers, spending time with their families, and so forth. The handset has a direct link to a transaction service that allows the existing member to sign the prospective member up for service. The transaction service associates the member's account or service with that of the prospective member's new account or service, thereby enabling the existing member to begin receiving benefits, such as commissions, for signing up the new member. Within a few days of signing up for new service, the new member receives their own handset in the mail. Upon activation of their new service, the new member is similarly enabled to acquire new subscribers.

Prospective members are also able to utilize a web service, such as through their own user devices, to sign up for new service using the same or similar transaction service. Embodiments also include social networking tools to obtain new members. A member may opt-in to have a link posted to their personal social networking page that enables individuals in their personal network to browse online and sign up for new service. The prospective members click on the link to sign up for new service and become new members. The link includes embedded information that enables the transaction service to associate the existing member's account or service with that of the new member's account or service in order to provide the existing member with benefits, such as commissions, for signing up the new member.

Embodiments of the present application empower existing members to receive benefits for signing up new members. By doing so, the mobile service provider is able to reduce or eliminate subscriber acquisition costs.

The processes, systems, and devices described herein may be implemented in a number of ways. Example implementations are provided below with reference to the following figures.

### Example Environments for New Member Acquisition

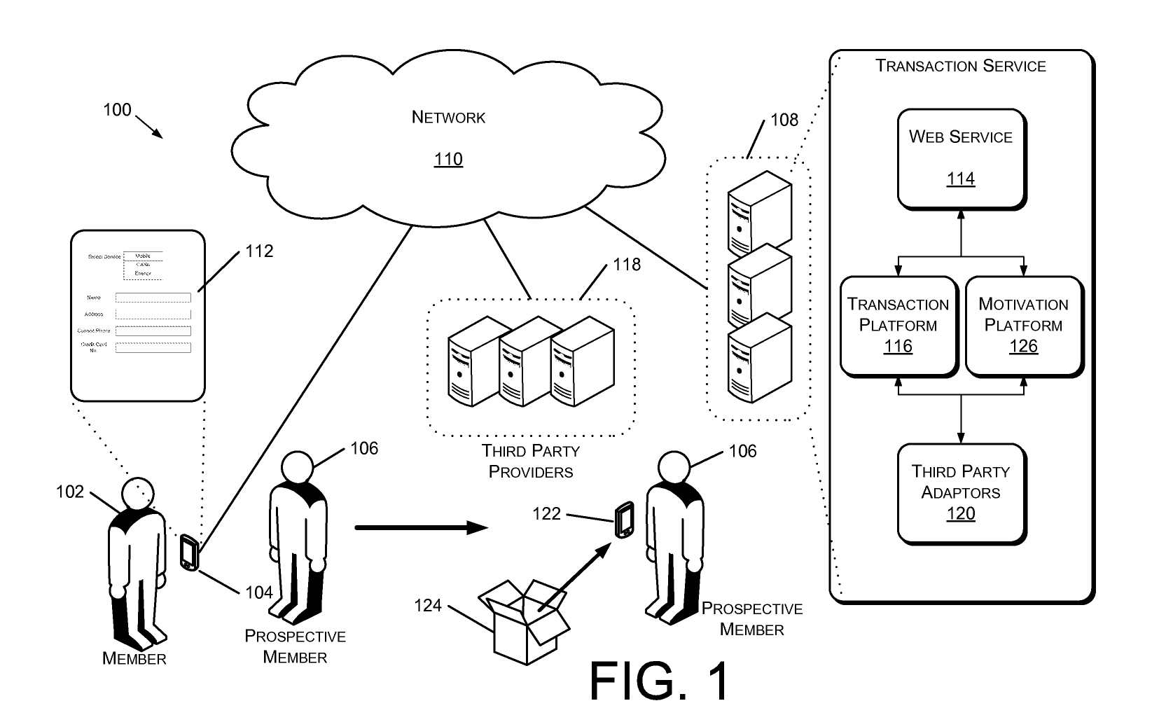

FIG. 1 is a schematic diagram of an example system 100 for acquisition of new members using mobile device tools. Aspects of the system 100 may be implemented on various suitable computing device types. Suitable computing device or devices may include, or be part of, one or more personal computers, servers, server farms, datacenters, special purpose computers, tablet computers, game consoles, smartphones, media players, combinations of these, or any other computing device(s).

Member 102 is a mobile service subscriber and he or she accesses a mobile service using a mobile device 104. During interaction with a prospective member 106, the member 102 is able to use the mobile device 104 to access transaction service 108 via a network 110. The member 102 interacts with a user interface on mobile device 104 to launch one or more transaction screens, such as transaction screen 112, which enable the prospective member 106 to sign up for new service and to become a member.

The one or more transaction screens provide input fields for the member 102 and/or the prospective member 106 to input the prospective member's information to sign up for the service. Through the one or more transaction screens, the prospective member 106 and/or the member 102 selects a desired handset make and model, enters in existing mobile service information, enters in their address and credit card information, and so forth. The prospective member 106 also selects phone delivery methods, and provides other information to customize their new service and to facilitate signing up for new service. The mobile device 104 may include a camera or other scanner for imaging or otherwise scanning the prospective member's credit card. In embodiments, mobile device 104 may be equipped with Bluetooth or other short-range wireless capability in order to serve up the transaction screens directly to the prospective member's 106 existing mobile device so that the prospective member 106 can enter the information directly into their own existing device.

In one embodiment, the mobile device 104 accesses a web service 114 via an installed browser and a soft link on a user interface screen of the mobile device 104. In these embodiments, the one or more transactions screens are served by the web service 114, and the prospective member's information is provided to the transaction service 108 via the web service 114 and the network 110. One or more transaction screens may be cached or stored locally on the mobile device 104 to enable the browser to access them directly rather than via the web service 114.

In another embodiment, the mobile device 104 includes an installed application that accesses the transaction platform 116 directly, or through the web service 114. The installed application may present the one or more transaction screens and transmit the prospective member's information to the transaction service 108 via the network 110. Alternatively, the installed application may download the transactions screens, or portions of the transaction screens, from the web service 114 or other portion of the transaction service 108.

A transaction platform 116 creates a new member account for the prospective member 106 in a secure member database. The transaction platform 116 associates the new member account or service with the member's 102 existing account or service, thereby adding to a relationship network for the member 102. The new member account or service may also be associated with other members' accounts or services in whose relationship networks member 102 is a member. These other accounts or services may include an account or service of a member who signed up the member 102 and accounts or services of other members above the member who signed up the member 102. Based on these associations, the transaction platform 116 is enabled to provide member 102, as well as other associated members, with benefits—such as commissions—for signing up the prospective member 106.

The transaction platform 116 interacts with one or more third party providers 118 via various corresponding third party adaptors 120. The third party providers may include, among other things, a commissioning provider, a fulfillment provider, a bank provider, a social networking provider, and so forth. The third party providers 118 carry out various functions on behalf of the transaction service 108.

In one example, a fulfillment provider may be instructed by the transaction platform 116 to ship a new mobile device 122 to prospective member 106. In this illustration, the new mobile device 122 arrives in a box 124, although in other implementations, the new mobile device may be delivered to the prospective member 106 in other ways. The prospective member 106 activates the new mobile device 122 and begins using the mobile service. The prospective member 106 may opt-in during the activation process or at some other time to use his or her existing social networking services to seek out new members. New mobile device 122 comes pre-configured with the same or similar member acquisition tools as are on the mobile device 104. Thus, the prospective member 106 is also enabled to seek out and sign up additional members.

The prospective member may also have the option to receive a Subscriber Identity Module (SIM) card in lieu of a new mobile device, such as where the prospective member's existing mobile device is compatible with the mobile service. Upon receipt of the SIM card, the prospective member can swap out their old SIM card for the new SIM card and activate their new service using their existing mobile phone.

The network 110 may include one or more wired and/or wireless networks such as the public Internet, local area networks, wide area networks, mobile carrier networks, personal area networks (PAN), and so forth. The mobile device 104 may access the network 110 using various technologies such as through Bluetooth® or other PAN technologies, Wi-Fi® technologies based on the IEEE 802.11 family of standards, Global System of Mobile Communication (GSM) standards-based technologies, code division multiple access (CDMA) mobile phone standards, and so forth. Embodiments of the present disclosure are not limited to any type or types of networking technologies or protocols.

In various embodiments, the member 102 may utilize something other than a mobile phone to access the network 110 and sign the prospective member 106 up to a new service. Thus, mobile device 104 may be a mobile phone (such as a smartphone), a tablet computer, a laptop computer, a netbook computer, a personal computer, or other device that has access to the network 110. Embodiments are not limited to particular type or types of devices for accessing the transaction service 108.

The transaction service 108 also includes motivation platform 126. The motivation platform 126 provides real-time, highly relevant alerts, messages, and reports that encourage the member to achieve additional levels of compensation or to reach other goals. Such messages are meant to motivate the member 102 to perform these activities, thereby driving additional member sign-ups. The motivation platform 126 creates the motivational report, social network feed, email, alert, instant message, or other communication and transmits it to the member 102. This may include sending social networking messages, via the third party adaptors, to reach a social networking provider. Alternatively or in addition, the motivation platform 126 may host or be associated with a social networking service that is accessible via the web service 114. The social networking messages may include message feeds, messages, reporting screens, and so forth. The environment of FIG. 1 depicts a real-time interaction between the member 102 and the prospective member 106. Next, social media tools for acquisition of new members will be described.

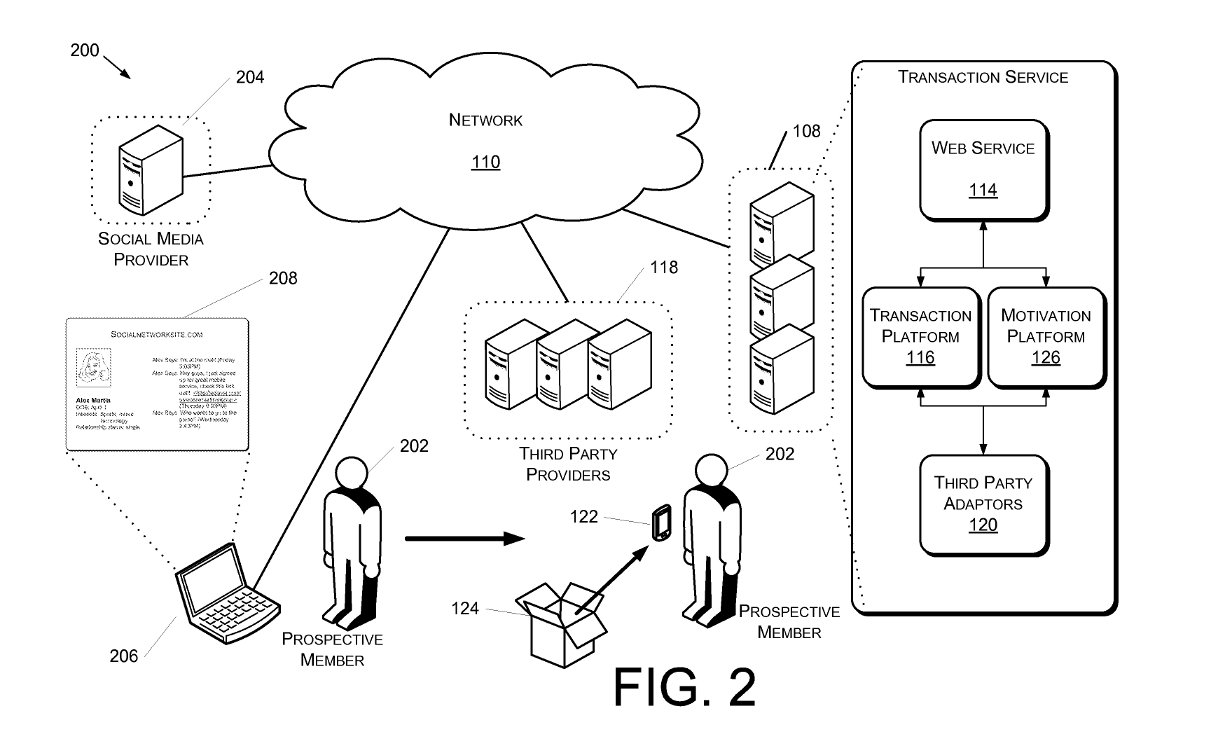

FIG. 2 is a schematic diagram of an example system 200 for acquisition of new members using social media tools. Referring to FIG. 2, a prospective member 202 accesses social media provider 204 using the personal computer 206. In embodiments, the prospective member 202 may utilize a netbook computer, a mobile phone, a tablet computer, or other device suitable for accessing the social media provider 204.

The personal computer 206 downloads social media page 208, which includes social media content. In one example, the social media page 208 is a social media page for an existing mobile service member, such as the member 102. The content on the social media page 208 includes a link to the web service 114. Clicking on the link within social media page 208 enables the prospective member 202 to browse to the web service 114 and to sign up for service through the transaction platform 116. Upon entering in their personal information and signing up for new mobile service, the prospective member 106 receives the new mobile device 122 (or a new SIM card) through a fulfillment provider of the third party providers 118 in the same or similar manner as is described with reference to FIG. 1.

The link to the web service 114 includes a resource identifier—such as universal resource identifier (URI) or a universal resource locator (URL)—that enables the personal computer 206 to access the web service 114. The link also includes embedded information that enables the transaction platform 116 to associate the existing member service with the newly created member service for the prospective member 106. This embedded information may be included as part of the URI or URL of the link. The embedded information may include some or all of the existing member's name, the existing member's phone number, the existing member's account number, a member number, or an anonymous identifier.

In this way, social media tools enable an existing member's online social media network to be leveraged for acquisition of new members. The transaction platform 116 utilizes the embedded information within social media links to associate the existing member's account or service to the new memberships that are generated through the link. The transaction platform 116 is configured to initiate bonus or commission payments for the existing member based on these associations.

### Example Transaction Screens

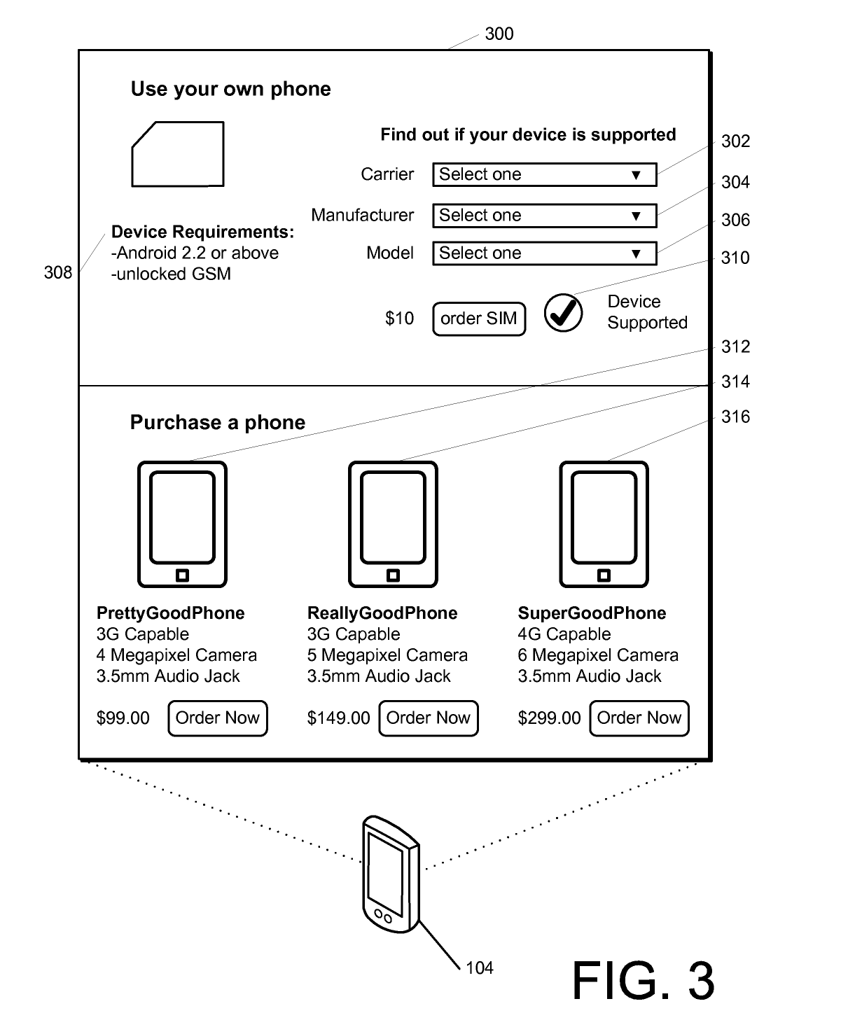

FIGS. 3-9 are example transaction screens that are displayed during the sign-up process. The transaction screens shown in FIGS. 3-9 are provided by the web service 114 or they may reside natively on a user device, such as the mobile device 104. The transaction screens shown in FIGS. 3-9 are examples only, and other transaction screens may be displayed without departing from embodiments. The example screens are shown displayed on the mobile device 104, but the same or similar screens could be displayed on other devices, such as on personal computer 206, the new mobile device 122, or on some other device. Although the descriptions of FIGS. 3-9 refer to the prospective member interacting with the example transaction screens another person, such as an existing member, may interact with the transaction screens on the prospective member's behalf—including entering some or all of the prospective member's information and choices into the transaction screens.

Referring to FIG. 3, a transaction screen 300 provides various options to order a SIM card for use with an existing phone and to purchase a new phone. User input fields 302, 304, and 306 provide a location for the prospective member to enter in his or her existing carrier as well his or her phone's manufacturer and model. A “device requirements” area 308 displays requirements for an existing phone to be used with the mobile service. A “device supported” message and a checkmark or other indicator 310 may be displayed if the prospective member's existing phone is compatible with the mobile service and meets the minimum requirements. Phone purchase options 312, 314, and 316 provide the prospective member with new phone choices in case the prospective member wishes to purchase a new phone or the prospective member has an incompatible phone. More or fewer new phone choices may be displayed on this or a different phone selection screen.

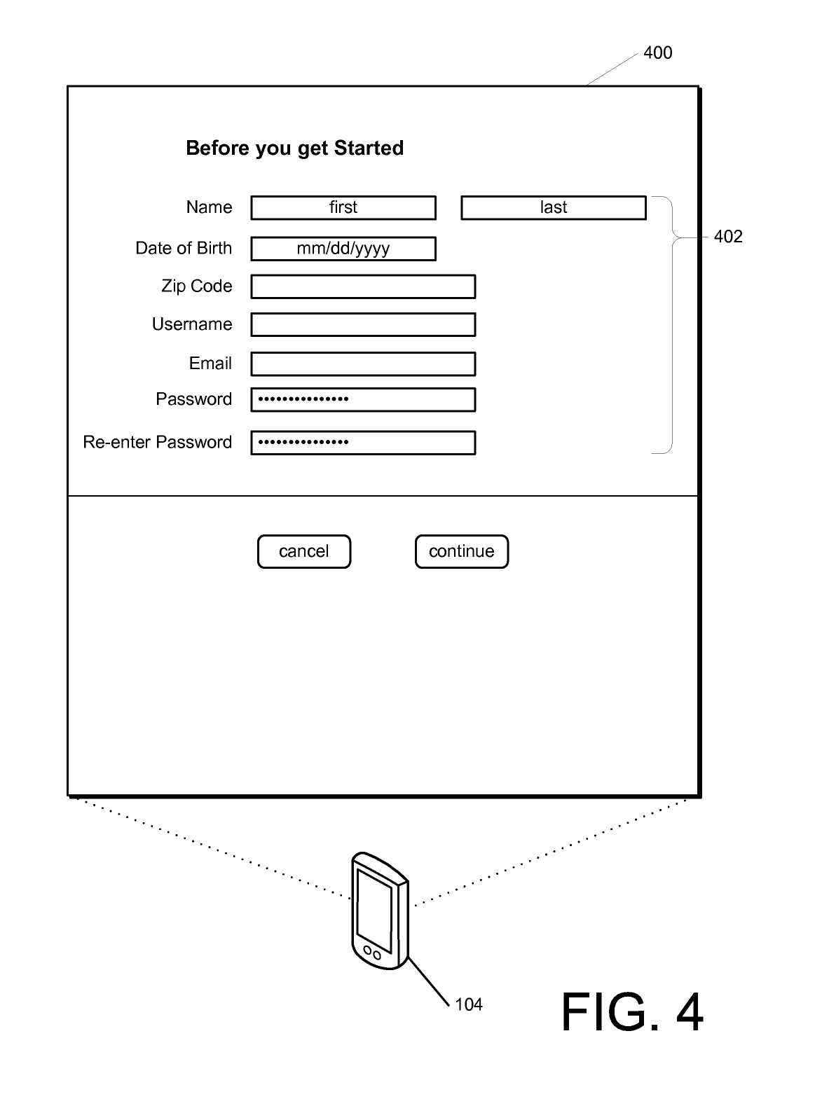

Referring to FIG. 4, a transaction screen 400 provides the prospective member with input fields 402 for inputting their personal information so that a member account can be created for him or her. More, fewer, or different input fields can be included without parting from the scope of embodiments.

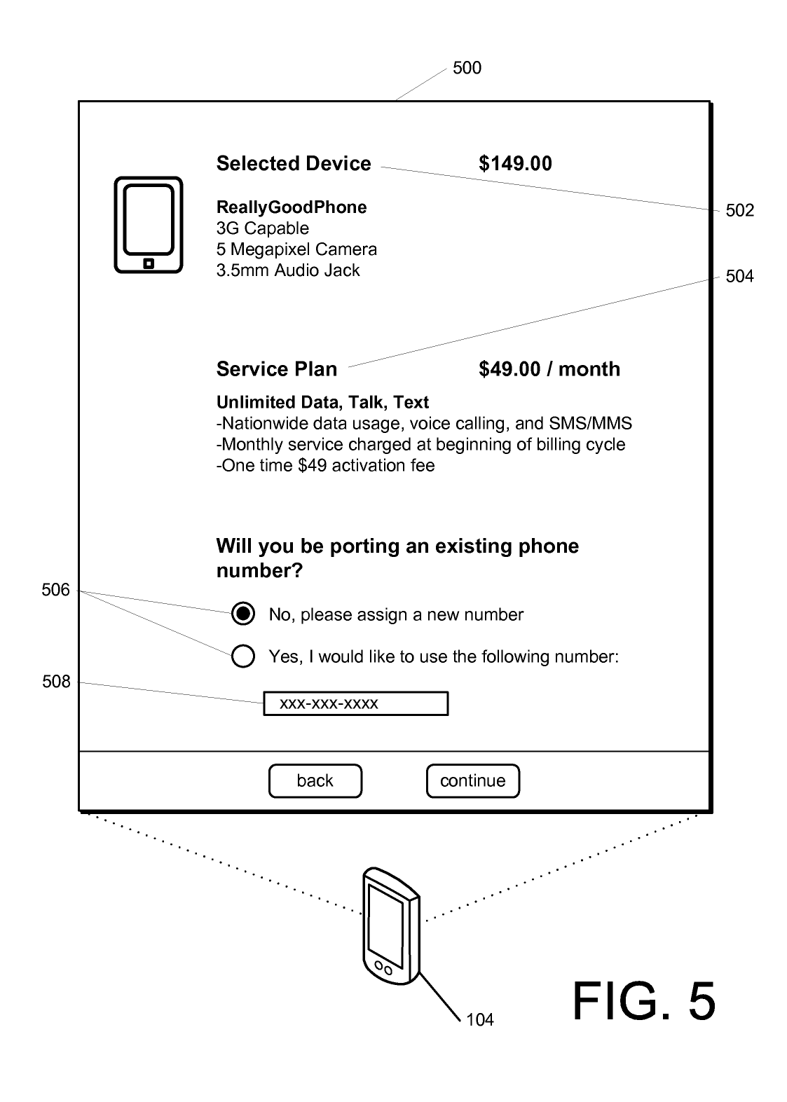

Referring to FIG. 5, a transaction screen 500 provides the prospective member with an overview of his or her selected device 502 and service plan 504. Transaction screen 500 also provides the prospective member with radio buttons 506 to select whether he or she wishes to port an existing telephone number to the new mobile service. A phone number input field 508 is usable to enter an existing phone number to be ported.

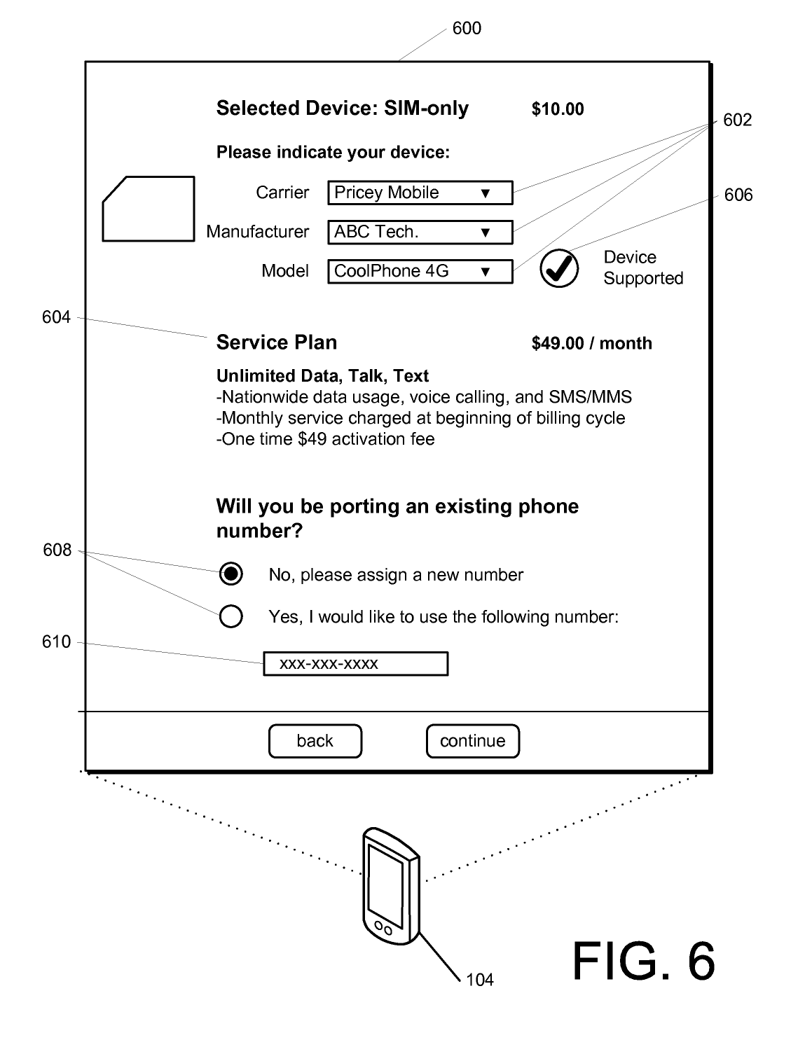

Referring to FIG. 6, a transaction screen 600 provides the prospective member with user input fields 602 to enter information about their existing device as well as an overview 604 of their service plan. This information may be pre-populated from data previously entered by the prospective member, such as onto the transaction screen 300, enabling the prospective member to confirm the information. An indicator 606 may be displayed on the transaction screen 600 to indicate that the device type entered by the prospective member is compatible with the mobile service. Transaction screen 600 also provides the prospective member with radio buttons 608 to select whether he or she wishes to port an existing telephone number to their new mobile service. A phone number input field 610 is usable to enter an existing phone number to be ported.

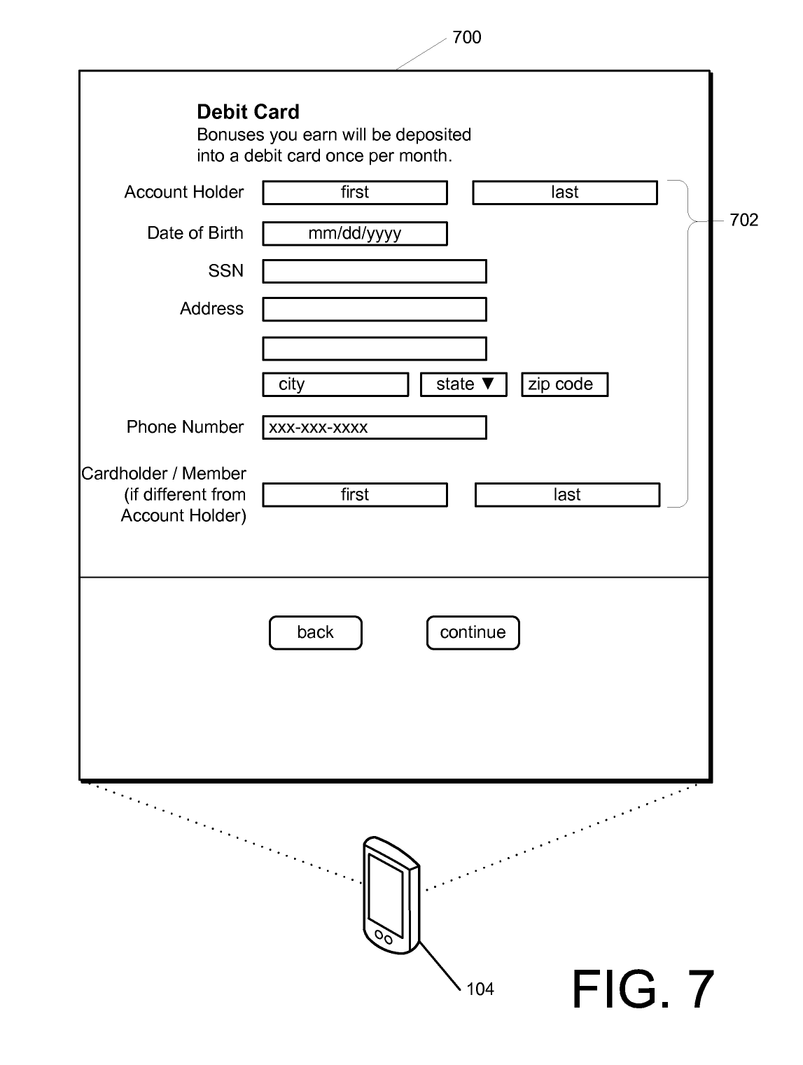

Referring to FIG. 7, a transaction screen 700 provides the prospective member with input fields 702. The input fields 702 enable the prospective member to enter personal information for the individual that will be issued a debit card to go along with the new mobile service. The debit card will be tied to a debit account used to pay bonuses and commissions to the new member.

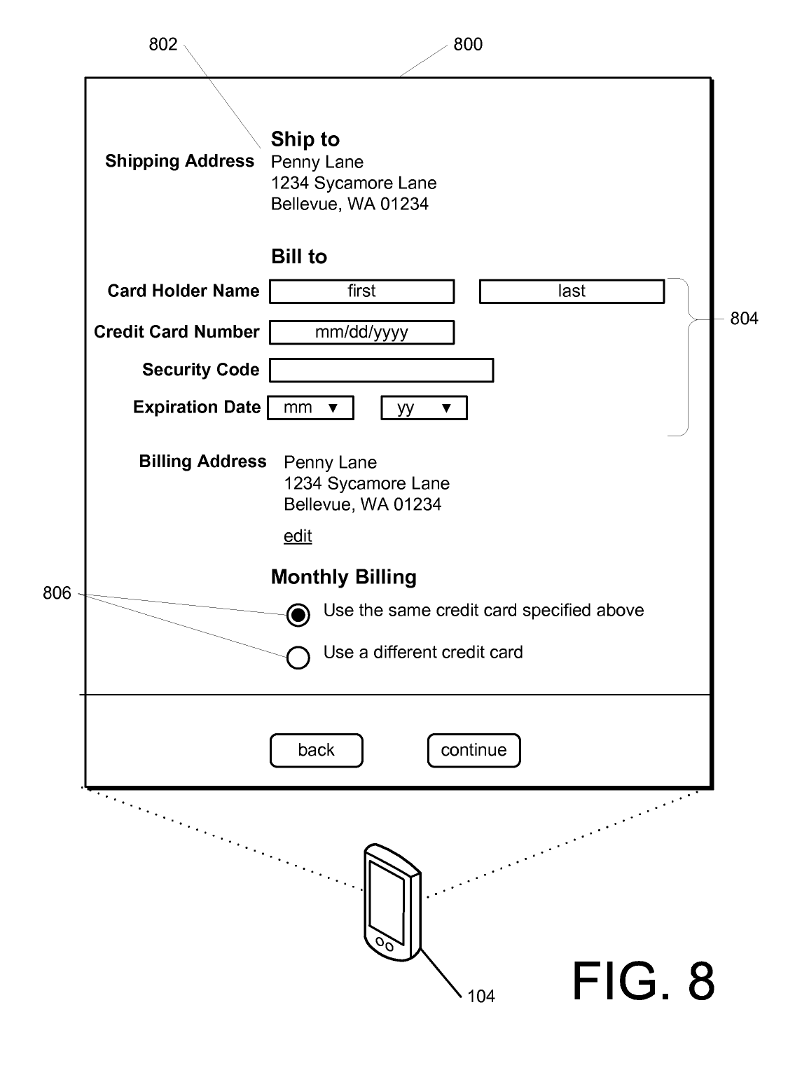

Referring to FIG. 8, a transaction screen 800 provides the prospective member with shipping and billing information. A shipping address 802 may be taken from the information entered in a previous screen, such as the transaction screen 700. Billing information 804 may be entered to specify a credit card to be used to purchase the phone or SIM card, to pay the monthly bill, an activation fee, and so forth. Radio buttons 806 are provided to enable the prospective member to choose to use the same or different credit card for future ongoing purchases.

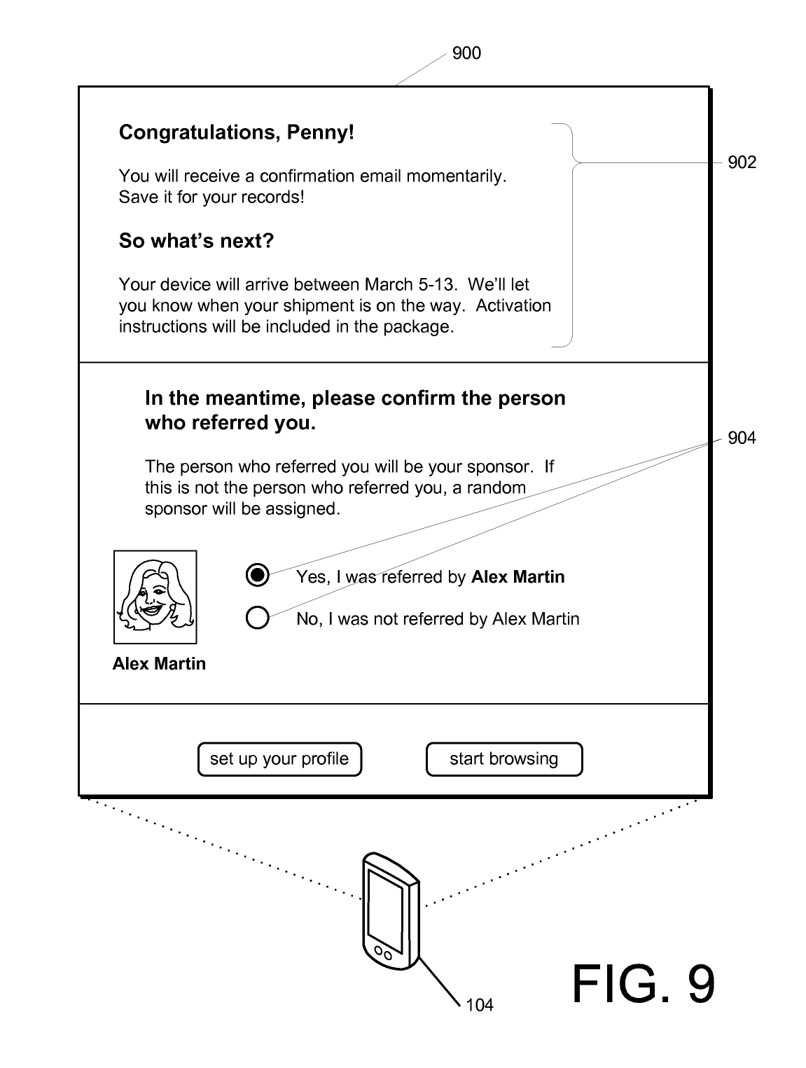

Referring to FIG. 9, a transaction screen 900 displays a service order confirmation message 902. The transaction screen 900 also provides the prospective member with the opportunity to confirm an identity of the referring member—such as the member 102—that signed them up for service. As noted elsewhere within this Detailed Description, information identifying the referring member may be transmitted to the transaction service 108 upon selecting a link for the web service 114 or upon selecting a selectable option on a mobile device, such as in the mobile device 104 to display the one or more transaction screens. This member information is used to propagate the referring member photograph and name shown in the transaction screen 900. Radio buttons 904 enable the prospective member to confirm or override the propagated referring member information. If the prospective member confirms that the member is the individual who referred them, then the prospective member's account is correlated with the referring member, and the referring member can receive bonuses or commissions for the referral as described elsewhere within this Detailed Description

### Example Social Networking Page According to Embodiments

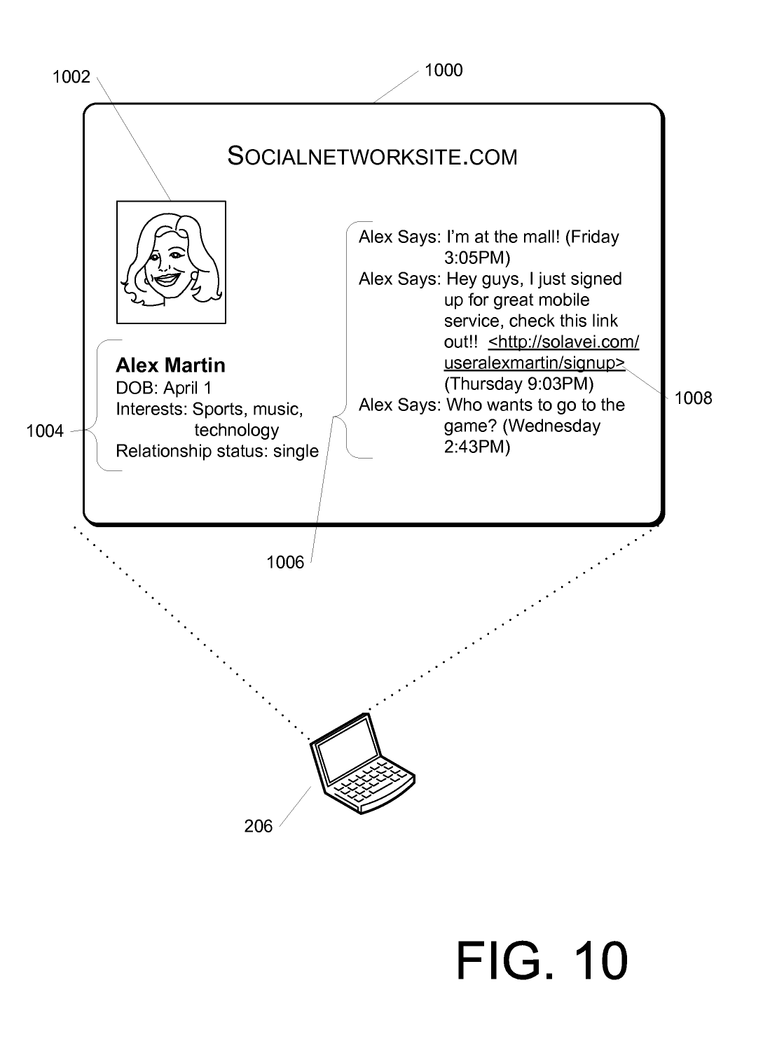

FIG. 10 illustrates an example social networking page 1000 with a selectable link that enables a member to solicit prospective members. The social networking page 1000 is retrievable from a social networking service, such as social media provider 204, and viewed by a prospective member on a personal computer, such as on the personal computer 206 or some other device.

The social networking page 1000 includes a profile picture 1002 and information 1004 regarding the existing member. The social networking page 1000 also includes a message posting area 1006 where the existing member is able to post messages to her social networking contacts. One of the messages includes a link 1008 to a web service, such as web service 114, that enables the prospective members that view the social networking page 1000 to sign up for new service. The link 1008 may be posted manually by the existing member, or the link 1008 may be posted in an automated fashion, such as during a service activation process or periodically by the transaction service 108. A member is able to opt-in or opt-out of the social networking link posting. Clicking on the link 1008 in the message posting area 1006 may cause the personal computer 206 to retrieve a transaction page that informs the prospective member of the service, provides pricing details, and allows the prospective member to proceed to sign up for service. The link 1008 includes embedded information (i.e., “useralexmartin”) that enables the transaction service 108 to correlate the referring member's account to the prospective member's account to enable other social networking functions as well as the calculation of bonuses, commissions, or other benefits for the referring member. A series of transaction pages, such as transaction screens 300, 400, 500, 600, 700, 800, and 900, may be retrieved in order to step the prospective member through the process of signing up for new service.

### Example Mobile Device for Member Acquisition

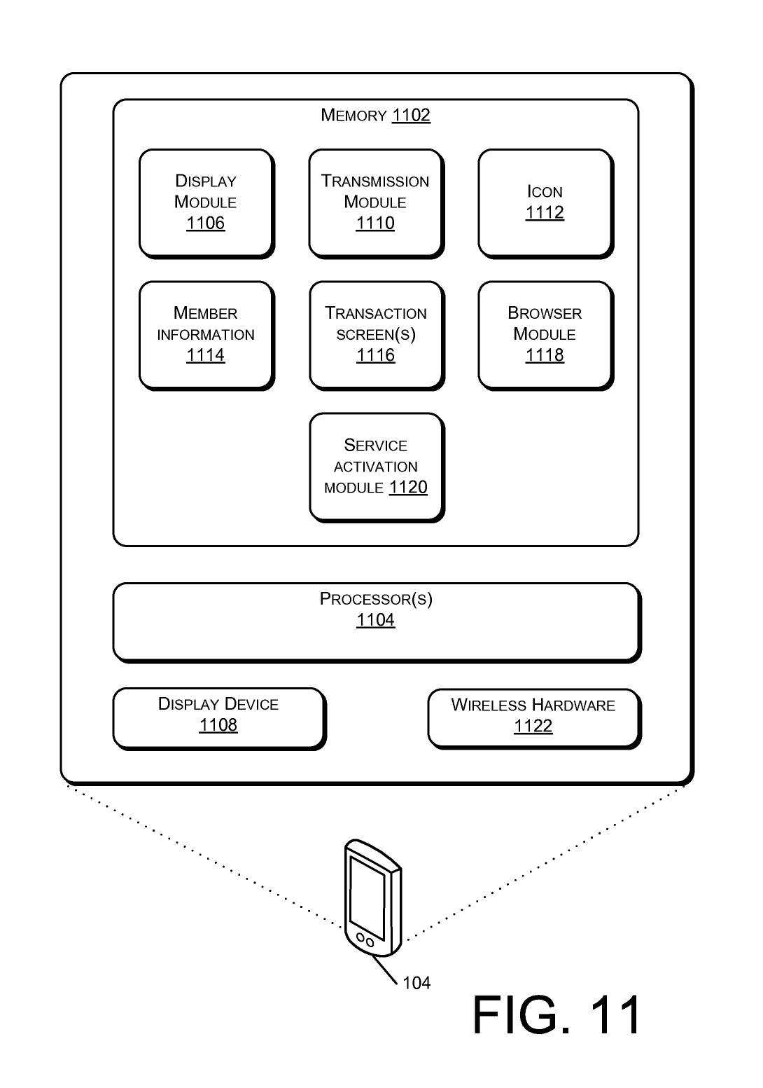

FIG. 11 is a block diagram of the example mobile device 104 usable to provide member acquisition tools according to embodiments. The mobile device 104 may be configured as any suitable computing device capable of implementing member acquisition tools. According to various non-limiting examples, suitable computing devices may include personal computers (PCs), servers, server farms, datacenters, special purpose computers, tablet computers, game consoles, smartphones, media players, combinations of these, or any other computing device(s).

Memory 1102 may store program instructions that are loadable and executable on the processor(s) 1104, as well as data generated during execution of, and/or usable in conjunction with, these programs.

Memory 1102 includes a display module 1106. The display module 1106 is executable to display a user interface on a display device 1108. The display device 1108 includes a display screen such as on a computer monitor, laptop computer, tablet computer, mobile phone, and so forth. The display device 1108 may be a touch-sensitive display configured to accept stylus and/or fingertip input. One or more of screens of the user interface displayed by the display module 1106 includes a selectable option, such as an icon 1112, that is associated with a transaction service, such as transaction service 108. In addition to an icon, such as the icon 1112, the selectable option may be a menu item, a user interface option, or other user interface element that is selectable via user input. The selectable option, which is also associated with member information 1114, is selectable via the user interface to cause one or more transaction screens 1116 to be loaded from a transaction service. The transaction screen 1116 may be the same as or similar to the transaction screens 300, 400, 500, 600, 700, 800, and 900.

For example, the selection of the selectable option may cause transmission module 1110 to launch and to display transaction screens 1116. The transmission module 1110 may be an installed application that is associated with the transaction service 108. One or more of the transaction screens 1116 may be stored or cached in the memory 1102 in a persistent manner, or one or more of the transactions screens 1116 may be downloaded as needed from the transaction service 108, such as from web service 114 or from some other component of the transaction service 108.

In another example, the selection of the selectable option may cause a browser module 1118 to launch and to retrieve the one or more transaction screens 1116 (either from a web service or from a local cache or store). The selectable option may be associated with a resource identifier, such as a universal resource identifier (URI) or universal resource locator (URL), that the browser module 1118 uses to locate the web service 114. In that case, the browser module 1118 is executable to download the one or more transaction screens 1116 from the web service 114.

Selection of the selectable option also causes transmission of the member information 1114 to the transaction service 108. For example, the transmission module 1110 may be configured to retrieve the member information 1114 from the memory 1102 and transmit it to the transaction service 108. In another example, the member information 1114 may be embedded within a resource identifier, such as a universal resource identifier (URI) or universal resource locator (URL), and the browser module 1118 or the transmission module 1110 transmits the member information 1114 upon requesting the one or more transactions screens 1116.

The transaction screen(s) 1116 are interactive to receive prospective member information for provision of a service for the prospective member. As noted elsewhere within this Detailed Description, the member information is usable by the transaction service 108 to correlate the provision of the service for the prospective member to an existing member service that is associated with the mobile device 104.

A service activation module 1120 is configured to present the member with one or more activation screens that enable the new member to activate his or her new mobile service. The service activation module 1120 executes on startup or at some other time. As part of the service activation process, the new member is provided with the option to enable social networking functions. For example, the new member may enter information regarding an existing social networking account and compose a message regarding his or her new mobile service to be posted to the social networking site. The service activation module 1120 generates a resource identifier, such as a URL or URI, to be posted along with the message to the member's social networking service. The resource identifier includes embedded information that identifies the new member and enables a transaction service to associate any new members signed up after clicking on the generated link with the member's service or account, thereby enabling commissioning and other features of the transaction service. The service activation module 1120 may come preconfigured on the mobile device 104. Alternatively, the service activation module 1120 may be downloaded and installed on the mobile device 104, such as part of a process of activating an existing phone for use with the new service.

Wireless hardware 1122 is used to communicate with the transaction service 108 via the network 110.

### Example Transaction System

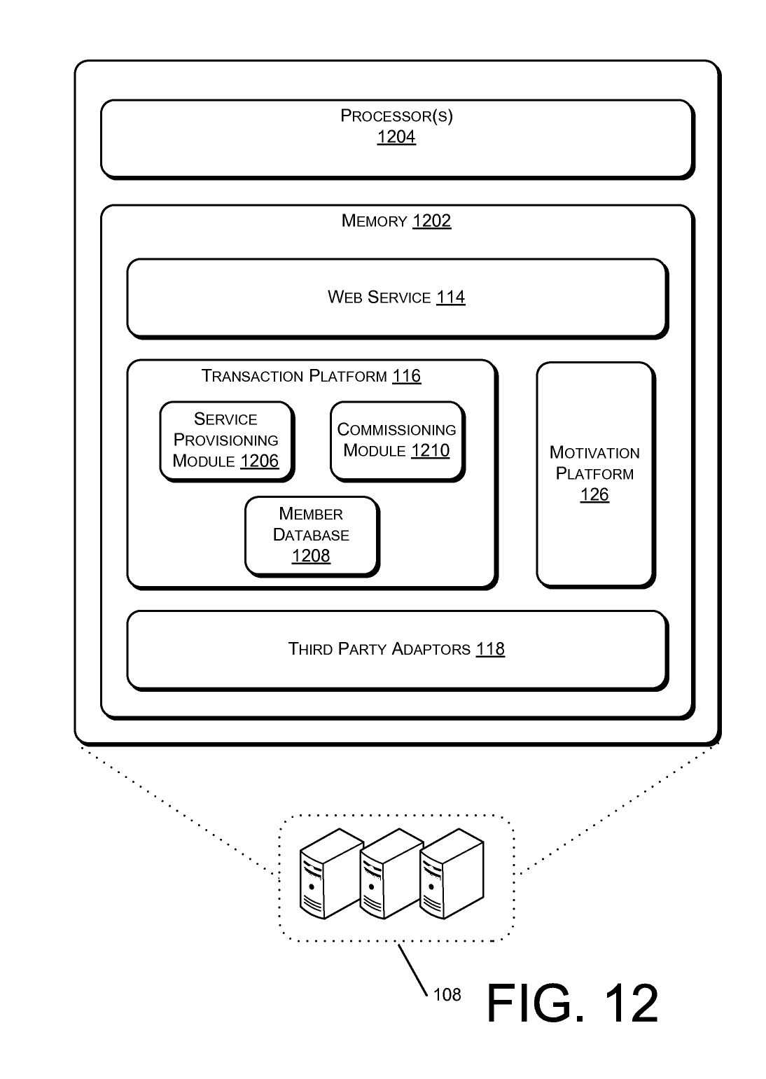

FIG. 12 is a block diagram of an example computing system usable to provide a transaction service. The transaction service 108 may be configured as any suitable computing device or computing devices capable of implementing member acquisition tools. According to various non-limiting examples, suitable computing devices may include or be part of personal computers (PCs), servers, server farms, datacenters, special purpose computers, tablet computers, game consoles, smartphones, media players, combinations of these, or any other computing device(s).

Memory 1202 may store program instructions that are loadable and executable on the processor(s) 1204, as well as data generated during execution of, and/or usable in conjunction with, these programs.

Memory 1202 includes the web service 114, the transaction platform 116, and the third party adaptors 120. The transaction platform 116 includes a service provisioning module 1206 which receives service provisioning information for a prospective member from the web service 114. The service provisioning request may be for a communication service (such as a wireless phone service), a television service, an energy service, or some other service. The service provisioning module 1206 initiates the provisioning of a new member service for the prospective member, which includes writing the prospective member's information to the member database 1208. The service provisioning module 1206 communicates with the third party adaptors 120 to facilitate the provisioning of the service for the prospective member, including the fulfillment of delivery of the handset or other device to the prospective member.

Additionally, the service provisioning module 1206 receives existing member information that corresponds to the member that is responsible for signing the prospective member up to new service. For example, the prospective member may sign up for the new service after clicking on a link to the transaction service 108 in the existing member's social networking page. In another example, the prospective member may sign up for the new service by interacting with the existing member who uses a member acquisition tool on their mobile device to sign up the prospective member to new service. As part of that process, the existing member's information is forwarded to the service provisioning module 1206. In the case of a soft link on the existing member's phone, and/or in the case of the prospective member clicking on a social networking link, the existing member information may be embedded within a resource identifier (such as a URL or URI). In any event, the service provisioning module 1206 causes the new service for the prospective member to be correlated in the member database 1208 with the existing member service. The prospective member may be provided with an option to verify the identity of the referring member.

A commissioning module 1210 is configured to initiate commissioning calculations for the members. This process includes looking up members in a member's network, as indicated by the correlations between the members' accounts in the member database 1208. In one example, if a first member signs up a second member, the first member receives a commission payment based on the second member's service payments. The commission payments may be calculated weekly, monthly, quarterly, annually, or at some other rate according to various embodiments. The commission payments may be calculated and paid only when the existing member signs up a new member. Alternatively, the commission payments may be calculated and paid on an ongoing basis (i.e., monthly, quarterly, etc.). The commission payments may be based on an initial sign-up of the new member, or they may be based on a portion of the new member's recurring charges. Memory 1202 also includes the motivation platform 126.

### Example Operations for Provisioning Service

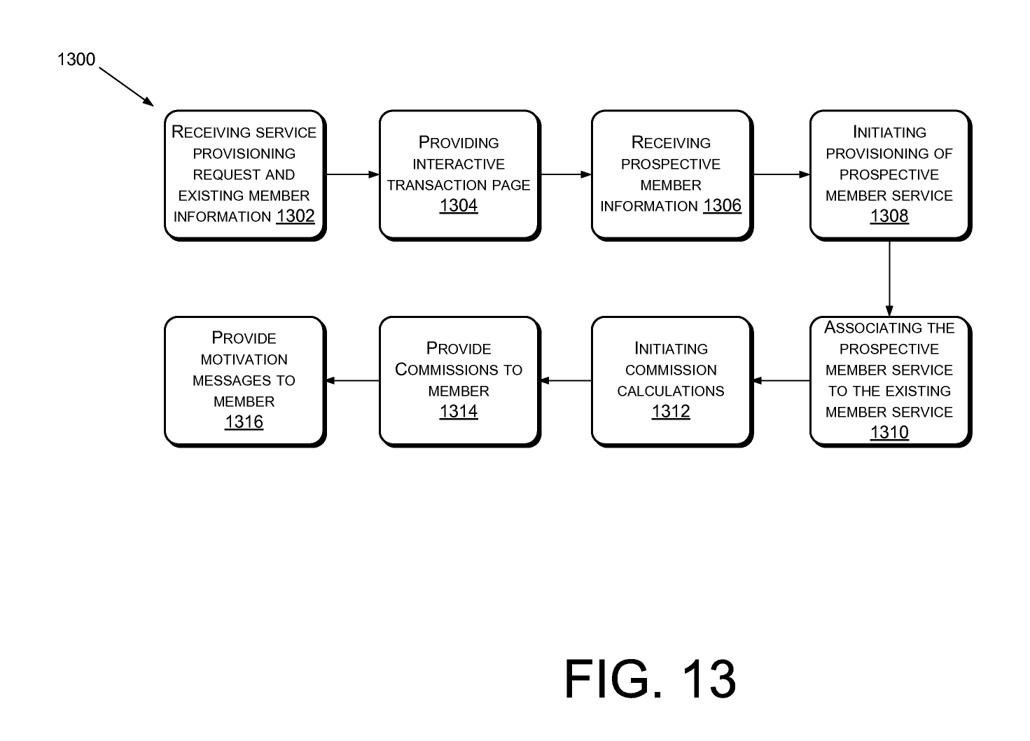

FIG. 13 is a flow diagram showing an example process 1300 for provisioning service for a prospective member. At 1302, a transaction service, such as the transaction service 108, receives a service provisioning request for a prospective member. Accompanying the service provisioning request is member information associated with an existing member service. For example, the existing member may sign up the prospective member using an application or a soft link on his or her mobile phone. Alternatively, the prospective member may sign up for service after clicking on a link presented in an existing member's social networking page. The existing member information includes an identifier (such as a name, phone number, account number, member number, or an anonymous identifier) that identifies the existing member. The existing member information or identifier may be embedded in a resource locater, such as in a URI or URL.

At 1304, the transaction service provides, in response to the request, one or more transaction screens or pages—such as the transaction screens 112, 300, 400, 500, 600, 700, 800, and 900—that are interactive to receive the prospective member's information such as name, address, existing service information, desired mobile phone, credit card information, and so forth. The one or more transaction screens may be presented as a series of screens for the user to input the requested information.

At 1306, the transaction service receives the prospective member information.

At 1308, the transaction service initiates provision of a service to the prospective member. This includes, among other things, interacting with third party providers via third party adaptors to establish communication, television, energy or other service. It also includes interacting with third party providers to fulfill delivery of any associated goods associated with the prospective member service such as a mobile phone, SIM card, cable box, satellite dish, energy monitor, and so forth. Initiating provision of the service also includes writing the prospective member information to a secure member database, such as the member database 1208.

At 1310, the transaction service associates the prospective member service to the existing member service. For example, the transaction service writes a flag to the new member's account in the secure member database indicating the association between the two services. This association enables commissioning payments to be calculated, enables existing members to obtain information on their member networks, and so forth. The new member service may also be associated with other member services that are associated with the existing member service. This may include members who have the existing member within their relationship network.

At 1312, the transaction service initiates commissioning for the member. This includes performing look-up operations to the member database to determine a member's network. Additional information may be included in the member database to facilitate the commission calculations, such as the members' monthly recurring charges, type of service, and so on. Commissioning may also be initiated for other members who have the new member within their relationship network.

At 1314, the transaction service causes compensation, such as commissions, bonuses, rewards and so forth, to be provided to the member. In embodiments, compensations may be deposited into an account that is associated with a debit card. The debit card may be used to make purchases.

At 1316, the motivation platform may provide the member with a motivational message, feed, report, alert, or other communication that encourages the member to take actions to increase their compensation. By receiving a highly relevant, real-time alert, the member is encouraged to engage in the activity.

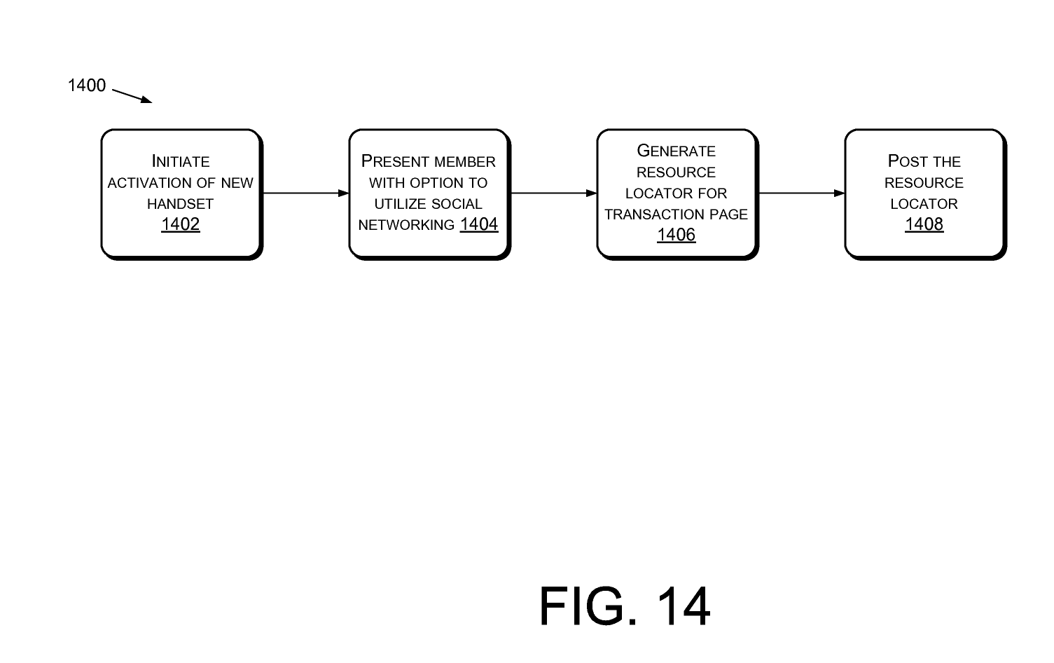

FIG. 14 is a flow diagram showing an example process 1400 for leveraging social networking services to solicit prospective members. At 1402, a service activation module—such as the service activation module 1120—initiates the activation of a new member's handset. This may include, among other things, presenting the new member with various activation screens. Activation may occur, for example, the first time that a new member powers on their new handset or at some other time.

At 1404, one or more of the activation screens presents an option for the new member to use an existing social networking service to solicit the new member's contacts to sign up for service. The member may also be presented with fields to input his or her social networking information such as the social networking site he or she belongs to, his or her login information, and so forth. The member may also be prompted to enter a message to be posted to the social networking site.

At 1406, the service activation module or a transaction service, such as the transaction service 108, generates a resource identifier. The resource identifier includes embedded member information that a transaction service, such as the transaction service 108, uses to associate a prospective member's service to the member's service. The embedded information may include some or all of the member's name, the member's phone number, the member's account number, a member number, or an anonymous identifier. The resource identifier may be generated at a time concurrent with the activation process, or at a later time once the member opts in to social networking.

At 1408, the service activation module or a transaction service posts the generated resource locator to the social networking service. The resource locator may be posted along with a message, such as a message drafted by the member. The message may describe or explain the service and what the link can be used for. The resource locator may be posted to a message center, such as a public message center that the member uses to share with those in his or her contact lists. Alternatively or additionally, the message and the resource locator may be pushed to those in the contact list, such as through email, text message, social networking private messages, instant messaging, and so forth.

Although FIG. 14 is described with reference to provisioning of new member service, resource locator generation such as is described with reference to FIG. 14 may be performed in other contexts, such as on a periodic basis after activation of the new member service. The resource locator generation may be performed, by something other than an activation module, either on the member's handset, the member's personal computer, tablet computer, personal data assistant, or by a transaction platform—such as the transaction platform 116. The resource locator generation may be initiated by the member, or a resource locator may be automatically generated by the transaction platform such as at predefined and/or programmable intervals.

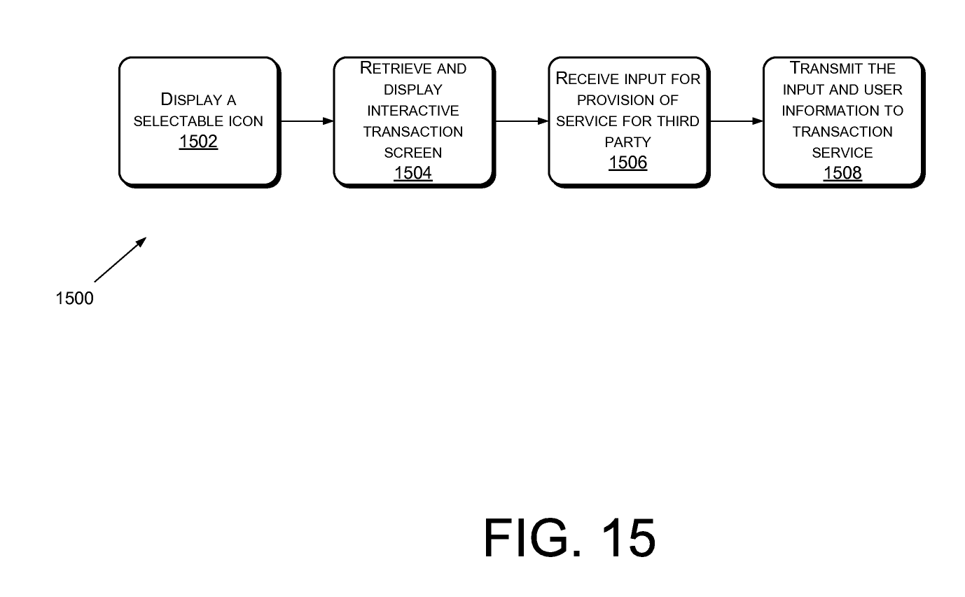

FIG. 15 is a flow diagram showing an example process 1500 for provisioning of member service through a member handset. At 1502, a display module—such as the display module 1106—displays a selectable option on a user interface of a mobile device, such as the mobile device 104. The selectable option is associated with a transaction service, such as the transaction service 108. The selectable option may be displayed on a home screen of the user interface, or on some other screen of the user interface. The selectable option may be an icon (such as icon 1112) a menu selection item, user interface selector, or other display item. In embodiments, the selectable option may be activated by user input such as by tapping on a touch-screen phone with a finger or stylus, using a pointing device, voice command, or by other method. The selectable option may be associated with a soft link that is associated with a resource identifier, such as a URI or URL. The mobile device, upon selection of the selectable option, launches a browser module to retrieve a transaction screen associated with the resource identifier. Alternatively, the selectable option is associated with an installed transaction application and the mobile device launches the installed transaction application upon selection of the selectable option.

At 1504, one or more interactive transaction screens, such as transaction screens 112, 300, 400, 500, 600, 700, 800, and 900, are retrieved and displayed in response to selection of the selectable option. The transaction screens are interactive to receive input for provision of a service for a prospective member. The transaction screens may be retrieved from a transaction service by a browser module or by a transaction module installed on the mobile device. Alternatively, the one or more transaction screens may be stored locally on the mobile device and displayed by the transaction module or the browser module. The one or more transaction screens include fields for input of user information.

At 1506, input for provision of the prospective member service is received. The input may include name, address, existing service information, desired mobile device, credit card information, and so forth. The input may be received by the transaction module or the browser module.

At 1508, the input for provision of new member service, as well as existing member information associated with the mobile device, are transmitted to the transaction service. The existing member information is usable by the transaction service to associate the provision of the service for the prospective member to the existing member service or account. The association of the existing member service to the new service for the prospective member may be used for, among other things, calculating bonuses or commission payments for the existing member. In one embodiment, the existing member information may be embedded in a soft link that is associated with the selectable option. Thus, the existing member information is transmitted to the transaction service at the time that the resource locator is initially forwarded to the transaction service.

FIGS. 13-15 depict flow graphs that show example processes in accordance with various embodiments. The operations of these processes are illustrated in individual blocks and summarized with reference to those blocks. These processes are illustrated as logical flow graphs, each operation of which may represent a set of operations that can be implemented in hardware, software, or a combination thereof. In the context of software, the operations represent computer-executable instructions stored on one or more computer storage media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be combined in any order, separated into sub-operations, and/or performed in parallel to implement the process. Processes according to various embodiments of the present disclosure may include only some or all of the operations depicted in the logical flow graph.

### Computer-Readable Media

Depending on the configuration and type of computing device used, memory 1102 and memory 1202 may include volatile memory (such as random access memory (RAM)) and/or non-volatile memory (such as read-only memory (ROM), flash memory, etc.). Memory 1102 and 1202 may also include additional removable storage and/or non-removable storage including, but not limited to, flash memory, magnetic storage, optical storage, and/or tape storage that may provide non-volatile storage of computer-readable instructions, data structures, program modules, and other data for mobile device 104 or transaction service 108.

Memory 1102 and memory 1202 are examples of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### CONCLUSION

Although the disclosure uses language that is specific to structural features and/or methodological acts, the invention is not limited to the specific features or acts described. Rather, the specific features and acts are disclosed as illustrative forms of implementing the invention.

1. A mobile device, comprising:
memory;
one or more processors; and
a display module stored on the memory and executable by the one or more processors to cause display of a user interface that includes a selectable option associated with member information of an existing member service associated with the mobile device, the selectable option being selectable via interaction with the user interface to cause a transaction screen to be displayed and to cause transmission of the member information to a transaction service, the transaction screen being interactive to submit a request that a prospective member be enrolled in a service, the request including financial information of the prospective member, the prospective member becoming a new member upon approval of the request by the transaction service, and wherein the member information is usable by the transaction service to correlate provision of the service for the new member to the existing member service that is associated with the mobile device.

2. The mobile device of claim 1, wherein the selectable option is further associated with a resource identifier, and wherein the selectable option is selectable to cause a browser module of the mobile device to request the transaction screen from the transaction service based on the resource identifier.

3. The mobile device of claim 2, wherein the member information is embedded within the resource identifier, and wherein the browser module transmits the member information embedded in the resource identifier to the transaction service upon requesting the transaction screen from the transaction service.

4. The mobile device of claim 1, further comprising a transaction module stored on the memory and executable by the one or more processors to access the transaction service via a wireless connection and to cause display of the transaction screen, wherein the selectable option is selectable to launch the transaction module and to cause the transaction module to load the transaction screen.

5. The mobile device of claim 1, wherein the service for the prospective member is one or more of a telecommunication service, an energy service, or a cable service.

6. A method comprising:
receiving from a user device, by a transaction service that executes on one or more processors of a computing system:
a service provisioning request to sign up a prospective member for a service,
financial account information of the prospective member; and
member information associated with an existing member service, the member information correlated with service provisioning request;
causing provision, by the transaction service, of a service according to the service provisioning request and the financial account information, the provision thereby causing the prospective member to become a new member; and
associating, by the transaction service, the service of the new member with the existing member service.

7. The method of claim 6, wherein the service provisioning request includes a resource identifier that includes the member information embedded within, and wherein the associating the service with the existing member service is based at least on the member information embedded within the resource identifier.

8. The method of claim 7, wherein the resource identifier is selectable by interaction with a selectable option of a user interface of the user device.

9. The method of claim 7, wherein the resource identifier is posted to a social networking service accessed by a user device.

10. The method of claim 6, further comprising providing to the user device, in response to the service provisioning request, a transaction page that is interactive to input the financial account information, for provision of the service.

11. The method of claim 6, wherein the service is one or more of a telecommunication service, an energy service, or a cable service.

12. The method of claim 6, wherein the existing member service is one or more of a telecommunication service, an energy service, or a cable service.

13. The method of claim 6, further comprising initiating, by the transaction service, commissioning for the existing member service, the commissioning based at least on the associating of the service to the existing member service.

14. The method of claim 6, further comprising generating, by a motivation platform, a communication for the existing member service that provides encouragement to perform activities that generate additional compensation.

15. A method comprising:
generating, by one or more processors of a computing system, a resource identifier that identifies a transaction page interactive to initiate a request to sign a prospective member up for a mobile phone service, thereby making the prospective member a new member, the resource identifier including embedded member information of an existing member that is usable to associate the service to an existing member service of the existing member; and
posting, by the one or more processors, the link to a social networking service.

16. The method of claim 15, wherein the posting is part of an activation of the existing member service.

17. The method of claim 15, wherein the existing member service is one or more of another mobile phone service, an energy service, or a television service.

18. Tangible computer-readable storage media comprising a plurality of programming instructions that are executable by one or more processors of a computing system to cause the computing system to:
display a selectable option in a user interface;
retrieve, at least partly in response to selection of the selectable option, an interactive transaction screen of a transaction service to be displayed in the user interface;
receive, via the transaction screen, input that indicates a request to provision a service for a prospective member, the input including financial information of the prospective member, the provision of the service for the prospective member making the prospective member a new member; and
transmit the input and existing member information associated with the computing system to the transaction service, the existing member information associated with an existing member service and usable by the transaction service to associate the provision of the service for the new member to the existing member service.

19. The tangible computer-readable storage media of claim 18, wherein the plurality of programming instructions are further executable to cause a browser module to retrieve the transaction screen from the transaction service based on a resource identifier associated with the selectable option.

20. The tangible computer-readable storage media of claim 19, wherein the member information is embedded in the resource identifier, and wherein the browser module is further configured to forward the member information embedded in the resource identifier.

21. The tangible computer-readable storage media of claim 18, wherein the plurality of programming instructions are further executable to cause a transaction module to retrieve the transaction screen and to transmit the member information to the transaction service.
